(19) United States
(12) Patent Application Publication
(10) Pub. No.: US 2015/0242497 A1
(43) Pub. Date: Aug. 27, 2015

(54) USER INTEREST RECOMMENDING METHOD AND APPARATUS

(71) Applicants: Xiang HE, Shenzhen (CN); Jianqun CHEN, Shenzhen (CN); Zhao FU, Shenzhen (CN)

(72) Inventors: Xiang HE, Shenzhen (CN); Jianqun CHEN, Shenzhen (CN); Zhao FU, Shenzhen (CN)

(21) Appl. No.: 14/708,093

(22) Filed: May 8, 2015

Related U.S. Application Data
(63) Continuation of application No. PCT/CN2013/084021, filed on Sep. 23, 2013.

(30) Foreign Application Priority Data
Nov. 9, 2012 (CN) 201210445772.7

(51) Int. Cl. G06F 17/30

(52) U.S. Cl. CPC G06F 17/30699; G06F 17/30598; G06F 17/30525; G06F 17/30864; G06Q 50/01

(57) ABSTRACT

Disclosed is a user interest recommending method and apparatus, where the method includes: obtaining, according to user-generated content of a social network, interest label information of users; clustering, according to the obtained interest label information, users having a same category of interest labels to form a cluster; and recommending interest labels of the users in the same cluster to the users in the cluster, and/or recommending the users in the same cluster to one another as friends with same interests. Because the interest labels of the users are obtained from user-generated content, accuracy of matching the interest labels is high. The interest labels or friends are recommended to the users in the cluster that is formed based on high accuracy, so the recommending accuracy is high, which improves recommending efficiency and the user interest labels.

### CROSS-REFERENCE TO RELATED APPLICATIONS

This application is a continuation of International Application No. PCT/CN2013/084021, filed Sep. 23, 2013, and claims priority to Chinese Patent Application No. 201210445772.7, filed Nov. 9, 2012, the disclosures of both of which are incorporated herein by reference in their entirety.

### FIELD OF THE TECHNOLOGY

The present disclosure relates to the field of social networks, and in particular, to a user interest recommending method and apparatus.

### BACKGROUND OF THE DISCLOSURE

The current social networks such as schoolmate, space, blog and microblog have enormous user groups. For better facilitating information exchange and communication between users, all social networks provide a user interest label service, which classifies, after a user matches a corresponding interest label, the user to a user group having the same interest label.

The current recommending method based on interest labels of users generally adopts the following manner: recommending interest labels randomly to users, or recommending interest labels to users according to current hot events, or recommending, after establishing a user interest label system, interest labels of different categories to the users.

The random recommendation is to select frequently used interest labels and recommend them to the users, and the recommendation according to current hot interest labels is to recommend interest labels that are active currently. The recommending manners cannot set interest labels that the users are actually interested in, and accuracy of interest label recommendation is not high.

### SUMMARY

An embodiment of the present invention is to provide a user interest recommending method, which aims to solve a problem of low accuracy of interest labels recommended to users in the existing technology, so as to improve efficiency of recommending user interest labels. The method can further recommend friends having same interests to users.

An embodiment of the present invention provides a user interest recommending method, including the following steps:

obtaining, according to user-generated content of a social network, interest label information of users;

clustering, according to the obtained interest label information, users having a same category of interest labels to form a cluster; and

recommending interest labels of the users in the same cluster to each of the users in the cluster, and/or recommending the users in the same cluster to one another as friends with same interests.

Another embodiment of the present invention provides a user interest recommending apparatus, including:

an obtaining module, configured to obtain, according to user-generated content of a social network, interest label information of users;

a clustering module, configured to cluster, according to the obtained interest label information, users having a same category of interest labels to form a cluster; and

a recommending module, configured to recommend interest labels of the users in the same cluster to each of the users in the cluster, and/or recommend the users in the same cluster to one another as friends with same interests.

In the embodiments of the present invention, according to the obtained interest label information in the user-generated content, users having the same category of interest labels are clustered to form the cluster, and the interests labels of the users in the same cluster are recommended to each of the users in the cluster, and/or users in the same cluster are recommended to one another as the friends with the same interests. Because the interest labels of the users are obtained from user-generated content, accuracy of matching the interest labels is high. The interest labels or friends are recommended to the users in the cluster that is formed based on high accuracy, so the recommending accuracy is high, which improves recommending efficiency and the user interest labels.

### BRIEF DESCRIPTION OF THE DRAWINGS

FIG. 1 is an implementation flowchart of a user interest recommending method provided by some embodiments of the present invention;

FIG. 2 is an implementation flowchart of a user interest recommending method provided by some embodiments of the present invention;

FIG. 3 is a structural block diagram of a user interest recommending apparatus provided by some embodiments of the present invention; and

FIG. 4 is a structural block diagram of a user interest recommending apparatus provided by some embodiments of the present invention.

### DESCRIPTION OF EMBODIMENTS

To make objectives, technical solutions and advantages of the present disclosure clearer, the present disclosure is further described in detail with reference to the accompanying drawings and the embodiments in the following. It should be understood that, the specific embodiments described herein are merely intended to explain the present invention, but are not intended to limit the present invention.

The method as disclosed as following may be implemented by any appropriate computing device having one or more processors and memory. The computing device, used herein, may refer to any appropriate device with certain computing capabilities (e.g., of controlling media data to be placed at a constant speed), and can perform a communicating connection with one computing device handled by another users. The computing device may be a personal computer (PC), a work station computer, a hand-held computing device (tablet), a mobile terminal (a mobile phone or a smart phone), a sever, a network server, a smart terminal, or any other user-side or server-side computing device. The memory includes storage medium, which may further include memory modules, e.g., a read-only memory (ROM), a random access memory (RAM), and flash memory modules, and mass storages, e.g., a CD-ROM, a U-disk, a removable hard disk, etc, which are all non-transitory storage mediums. The storage medium may be a non-transitory computer readable storage medium that stores program modules for implementing various processes, when executed by the processors.

### Embodiment 1

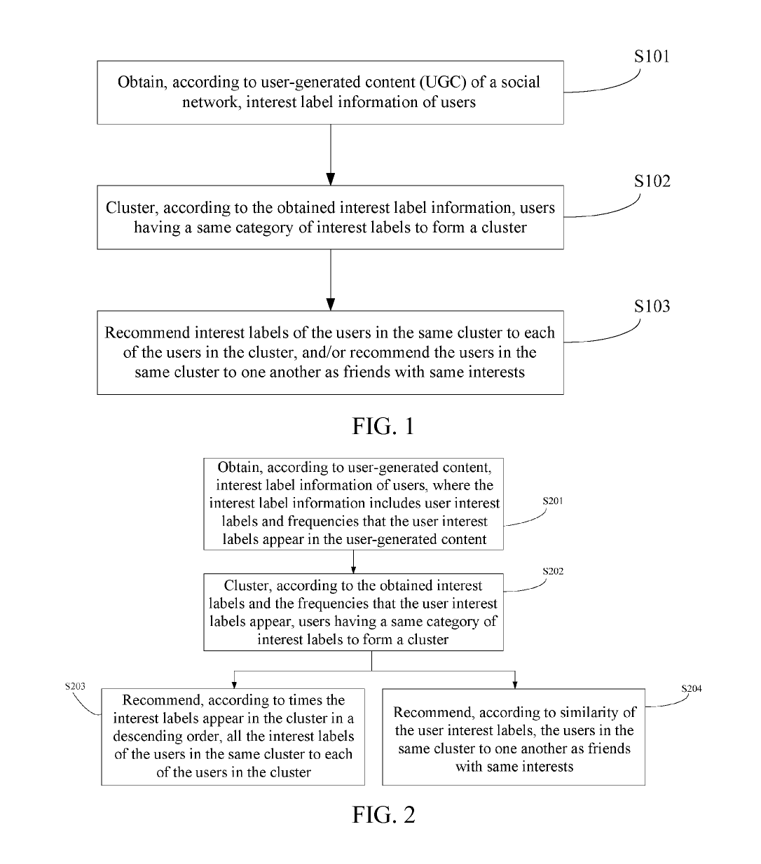

FIG. 1 shows an implementation process of a user interest recommending method of the embodiment of the present invention, which is described in detail in the following.

Step S101: Obtain, according to user-generated content of a social network, interest label information of users.

Specifically, interest labels are words used by the users to describe themselves, for example, a user may use words such as “basketball”, “NBA”, “Jeremy Lin” as interest labels to describe his/her interests. The user-generated content (UGC) includes microblogs and blogs posted by users, reposted articles or personal signatures.

The obtaining, according to user-generated content UGC of a social network, interest label information of users may be performed through one or two manners exemplified in the following or other manners.

In a first manner, the interest label information of the users are searched for in the user-generated content, which can be specifically implemented by establishing a library including frequently used interest labels. According the interest labels in the interest label library, whether key words matching the interest labels in the interest label library appear in the user-generated content is determined, and if the key words appear, the appearing key words are used as interest labels matching the users. For example, if an interest label library includes “NBA”, “science fiction movie”, “political fiction”, “born in 80s” and the like, and the user-generated content includes keys words “NBA” and “science fiction movie”, the two interest labels “NBA” and “science fiction movie” are matched and associated with a user.

In a second manner, in a case that a user has customized interest labels or key words of information published by the user are obtained, the customized interest labels and the key words of the published information are used as interest labels of the user, such as key words in an article published by the user, or self description in interest label impression.

Step S102: Cluster, according to the obtained interest label information, users having a same category of interest labels to form a cluster.

The cluster refers to a set of users having same or similar interest labels. According to the interest label information obtained based on the user-generated content, the users having the same category of interest labels are clustered to form the cluster, so as to improve accuracy of clustering the users. For example, for users all having an interest label “Jeremy Lin”, multiple users having same or similar interest labels may exist, and therefore, clustering may be performed by adopting any common clustering algorithm such as a hierarchical clustering algorithm.

The hierarchical clustering algorithm includes an agglomerative algorithm and a divisive algorithm. The agglomerative algorithm is performed in a “bottom up” approach. Firstly, each user is used as a cluster; and then clusters with greatest similarity are merged as a big cluster until all clusters are merged into one big cluster. The agglomerative algorithm starts from n clusters, and ends with one cluster. The divisive algorithm is performed in a “top down” approach. Firstly, the divisive algorithm views the entire sample as a big cluster, and then, all possible split methods are inspected during a process of performing the algorithm to divide the entire cluster into several small clusters. The first step is to divide into two types; the second step is to divide into three types; and the procedure can be repeated until n types are obtained in the last step. A split making a difference degree the smallest is selected in each step. This method can obtain a system tree with an inverse structure, which starts form one cluster, and ends with n clusters. Multiple clusters with different similarities are acquired from the system tree.

Step S103: Recommend interest labels of the users in the same cluster to each of the users in the cluster, and/or recommend the users in the same cluster to one another as friends with same interests.

Specifically, the cluster obtained in step S102 includes multiple users having same or similar interests. According to characteristics of the users in the cluster, at least one of the following user interest recommending manners may be used.

1. Take statistics of the interest labels of the users in the same cluster, and recommend the user interest labels in the cluster to each of the users in the cluster; when a user interest label is recommended, a determining step may be included to determine whether a user has the recommended interest label; if not, the interest label is recommended to the user, and if yes, the next interest label is recommended to the user; this can prevent a situation of repeatedly recommending interest labels that a user already has to the user, so as to improve the user experience.

2. Recommend the users in the same cluster to one another as friends with same interests; likewise, a determining step may also be included before recommending to determine whether a user to be recommended is a friend of a target user of recommendation; if not, the user to be recommended is recommended as a friend to the target user of recommendation, and otherwise, the next user is recommended.

The embodiment of the present invention obtains the interest label information of the users in the user-generated content, so as to acquire real user interest labels; the users are clustered to acquire the cluster based on the user interest labels; the user interest labels and/or friends of the users are recommended in the cluster; and the user interest labels obtained in the embodiment of the present invention are real, which improves accuracy and efficiency of recommending user interest labels and users.

### Embodiment 2

FIG. 2 is a flowchart of a user interest recommending method provided by some embodiments of the present invention, which is described in detail in the following.

Step S201: Obtain, according to user-generated content, interest label information of users, where the interest label information includes user interest labels and frequencies that the user interest labels appear in the user-generated content.

Sources of the user interest labels include the user-generated content and interest labels customized by users.

While the user interest labels are acquired from the user-generated content, times that the user interest labels appear in the user-generated content are counted. The appearing times of the interest labels may also be counted when the labels are matched to the user-generated content. The generated user interest label information is in forms such as sports 20, basketball 25, mountain climbing 80 and ping pong 15.

Step S202: Cluster, according to the obtained interest labels and the frequencies that the user interest labels appear, users having a same category of interest labels to form a cluster.

The obtained user interest label information includes the user interest labels and the frequencies that the interest labels appear; and when the users are clustered, for the users having same user interest labels, the frequencies that the user interest labels appear are used to determine different similarities. For example, a user A, a user B and a user C all have an interest label “basketball”; a frequency of the interest label of the user A is 38; a frequency of the interest label of the user B is 40; a frequency of the interest label of the user C is 5; and when similarities are determined, the similarity between A and B is higher than the similarity between A and C or B and C.

Step S203: Recommend, according to times the interest labels appear in the cluster in a descending order, all the interest labels of the users in the same cluster to each of the users in the cluster.

After the cluster is obtained, the user interest labels in the cluster are counted, so as to acquire user interest labels with more appearing times or higher accumulative appearing frequencies in the cluster; Embodiment 2 differs from Embodiment 1 in that appearing times of the interest labels are also counted in this embodiment, and interest labels with more appearing times are recommended preferentially when the interest labels are recommended, so as to improve a success rate and accuracy of recommending.

Step S204: Recommend, according to similarity of the user interest labels, users in the same cluster to one another as friends with same interests.

After the cluster is obtained, the similarity of the interest labels of the users and appearing times of a same interest label in the cluster are counted; and after same or similar interest labels of two users reach a set number or appearing times of same or similar interest labels reach a certain value, the two users are determined as friends. Certainly, similar to Embodiment 1, determining whether a user is a friend can further be included before recommending.

It may be understood that the user interest recommending method of the embodiment of the present invention described above includes two recommending steps, namely, step S203 and step S204, but the method does not necessarily include both two steps; according to actual needs, the method may include only step S203, only step S204, or both two steps.

In addition, as another implementation manner of the embodiment of the present invention, feature information of a social network of users may further be included, such as the age, name and occupation of a user in user registration information. In the clustering step, according to the obtained interest label information and the feature information of the social network of the users, the users having the same category of interest labels are clustered to form the cluster. Because the feature information of the users may further locate characteristics of the users, the accuracy of determining user similarity is improved.

Compared with Embodiment 1, when the interest label information is acquired according to the user-generated content, this embodiment further includes: obtaining appearing times of the interest labels; clustering the users according to the user interest labels and the appearing times; after the clusters are acquired, recommending the interest labels and friends according to the user interest labels and the appearing times of the interest labels. Because the frequencies that the interest labels appear are considered when the clusters are generated and recommending is performed, recommending accuracy and efficiency may further be improved. In addition, the feature information of the users may also improve the recommending accuracy and efficiency.

### Embodiment 3

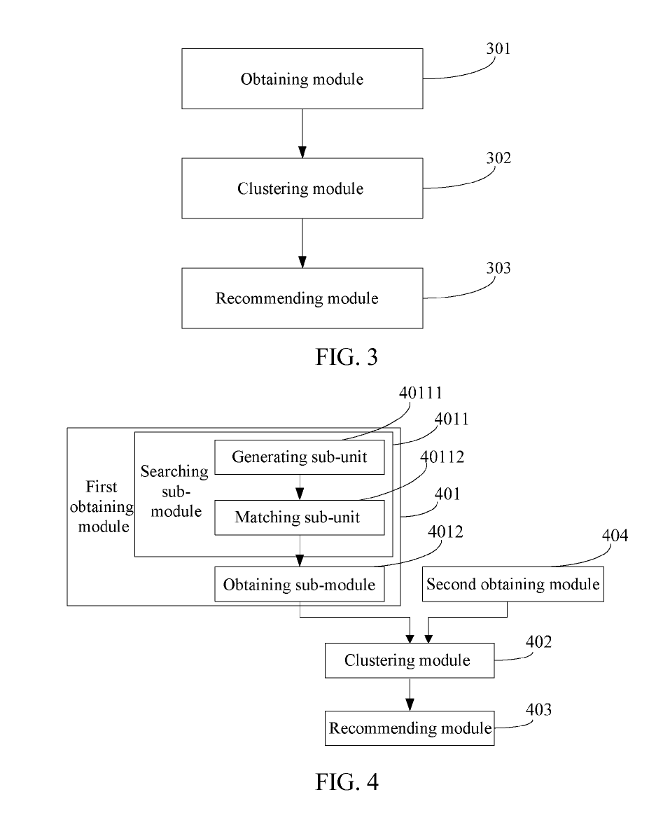

FIG. 3 is a structural block diagram of a user interest recommending apparatus provided by the embodiment of the present invention, which is described in detail in the following.

The user interest recommending apparatus described in the embodiment of the present invention runs in a computing device that includes a memory, one or more processors, and a plurality of program modules. The plurality of program modules include computer-implemented instructions that are stored in memory and executed by the one or more processors. The plurality program modules include an obtaining module 301, a clustering module 302 and a recommending module 303.

The obtaining module 301 is configured to obtain, according to user-generated content UGC of a social network, interest label information of users;

The clustering module 302 is configured to cluster, according to the obtained interest label information, users having a same category of interest labels to form a cluster.

The recommending module 303 is configured to recommend interest labels of the users in the same cluster to each of the users in the cluster, and/or recommend the users in the same cluster to one another as friends with same interests.

The obtaining module 301 obtains, according to the user-generated content, the interest label information of the users. The clustering module 302 clusters according to the interest label information of the users, and the clustering method adopted by the clustering module 302 is a mature hierarchical clustering algorithm in the existing technology, such as the AGNES algorithm. After the cluster is acquired, the interest labels of the users in the cluster are counted. After the counting, the interest labels are recommended to each of the users in the cluster, and/or the users in the cluster are recommended to one another as friends. Because the interest labels are generated from the user-generated content, the accuracy is high. Therefore, after the cluster is acquired, accuracy of recommending user interest labels and users is better, and the efficiency is higher.

### Embodiment 4

FIG. 4 is a structural block diagram of a user interest recommending apparatus provided by the embodiment of the present invention, which is described in detail in the following.

The user interest recommending apparatus described in the embodiment of the present invention includes runs in a computing device that includes a memory, one or more processors, and a plurality of program modules. The plurality of program modules include computer-implemented instructions that are stored in memory and executed by the one or more processors. The plurality program modules include a first obtaining module 401, a clustering module 402 and a recommending module 403.

The first obtaining module 401 is configured to obtain, according to user-generated content UGC of a social network, interest label information of users, where the interest label information includes user interest labels and times the user interest labels appear in the user-generated content of the social network.

The clustering module 402 is configured to cluster, according to the obtained interest label information, users having a same category of interest labels to form a cluster.

The recommending module 403 is configured to recommend, according to times the interest labels appear in the cluster in a descending order, the interest labels of the users in the same cluster to each of the users in the cluster, and/or recommend, according to similarity of user interest labels, users in the same cluster to one another as friends with same interests.

The first obtaining module 401 specifically includes:

a searching sub-module 4011, configured to search for the interest label information of the users in the user-generated content; and/or

an obtaining sub-module 4012, configured to obtain customized interest label information in the user-generated content.

The searching sub-module 4011 specifically includes:

a generating sub-unit 40111, configured to generate a library including frequently used interest labels; and

a matching sub-unit 40112, configured to search for key words matching the interest labels in the interest label library in the user-generated content, and use the matching key words as the user interest labels.

As another implementation manner of the embodiment of the present invention, the apparatus further includes a second obtaining module 404, configured to obtain feature information of the social network of the users, and the clustering module 402 is specifically configured to cluster, according to the obtained interest label information and the feature information of the social network of the users, the users having the same category of interest labels to form the cluster.

The first obtaining module 401 obtains the interest label information of the users, which includes the interest labels and times the interest labels appear in the user-generated content; and the clustering module 402 clusters the users according to the interest label information of the users, so as to obtain the cluster. For the users in the same cluster, the recommending module 403 recommends, according to the interest labels of the users and the appearing times of the interest labels, the users in the cluster to one another as friends and/or recommends the interest labels of the users in the cluster to each of the users in the cluster. To further improve clustering accuracy, the second obtaining module obtains the feature information of the users, so as to provide more accurate data for determining the clustering and recommendation. The apparatus embodiment of the present invention corresponds to the method embodiment of Embodiment 2, which is not described again herein.

The embodiment of the present invention obtains the user interest labels from the user-generated content UGC; after the cluster is acquired according to the user interest labels, the interest labels of the users in the cluster are recommended to each of the users in the cluster and/or the friends in the cluster are recommended to one another as friends. Because the user interest labels are obtained from the user-generated content, accuracy of the obtained interest labels is high, so that a success rate of recommending users or interest labels is high, and adding the feature information of the users and the appearing times of the user interest labels may further improve accuracy of recommending users.

The above descriptions are merely preferred embodiments of the present invention, and are not intended to limit the present disclosure. The sequence numbers of the above embodiments of the disclosure are only for the purpose of description, and do not represent one embodiment is superior to another. Any modification, equivalent replacement, or improvement made within the spirit and principle of the present disclosure shall fall within the protection scope of the present disclosure.

What is claimed is:

1. A user interest recommending method, comprising:
obtaining, according to user-generated content of a social network, interest label information of users;
clustering, according to the obtained interest label information, users having a same category of interest labels to form a cluster; and
recommending interest labels of the users in the same cluster to each of the users in the cluster, and/or recommending the users in the same cluster to one another as friends with same interests.

2. The method according to claim 1, wherein the obtaining, according to user-generated content of a social network, interest label information of users comprising:
searching for the interest label information of the users in the user-generated content; and/or
obtaining customized interest label information in the user-generated content.

3. The method according to claim 2, wherein the searching for the interest label information of the users in the user-generated content specifically is:
generating a library including frequently used interest labels; and
searching for key words matching the interest labels in the library of interest labels in the user-generated content, and using the matching key words as the user interest labels.

4. The method according to claim 1, wherein the interest label information comprises interest labels of the users and times the interest labels appear in the user-generated content of the social network.

5. The method according to claim 4, wherein the recommending interest labels of the users in the same cluster to each of the users in the cluster, and/or recommending the users in the same cluster to one another as friends with same interests specifically is:
recommending, according to the times the interest labels appear in the cluster in a descending order, the interest labels of the users in the same cluster to each of the users in the cluster, and/or recommending, according to similarity of the user interest labels, the users in the same cluster to one another as friends with same interests.

6. The method according to claim 1, further comprising obtaining feature information of the social network of the users, wherein
the clustering, according to the obtained interest label information, users having a same category of interest labels to form a cluster specifically is:
clustering, according to the obtained interest label information and the feature information of the social network of the users, the users having the same category of interest labels to form the cluster.

7. A user interest recommending apparatus, comprising:
an obtaining module, configured to obtain, according to user-generated content of a social network, interest label information of users;
a clustering module, configured to cluster, according to the obtained interest label information, users having a same category of interest labels to form a cluster; and
a recommending module, configured to recommend interest labels of the users in the same cluster to each of the users in the cluster, and/or recommend the users in the same cluster to one another as friends with same interests.

8. The apparatus according to claim 7, wherein the obtaining module specifically comprises:
a searching sub-module, configured to search for the interest label information of the users in the user-generated content; and/or
an obtaining sub-module, configured to obtain customized interest label information in the user-generated content.

9. The apparatus according to claim 8, wherein the searching sub-module comprises:
a generating sub-unit, configured to generate a library including frequently used interest labels; and
a matching sub-unit, configured to search for key words matching the interest labels in the library of interest labels in the user-generated content, and use the matching key words as the user interest labels.

10. The apparatus according to claim 7, wherein the interest label information comprises the interest labels of the users and times the interest labels appear in the user-generated content of the social network.

11. The apparatus according to claim 10, wherein the recommending module is specifically configured to: recommend, according to the times the interest labels appear in the cluster in a descending order, the interest labels of the users in the same cluster to each of the users in the cluster, and/or recommend, according to similarity of the user interest labels, the users in the same cluster to one another as friends with same interests.

12. The apparatus according to claim 7, further comprising: a second obtaining module, configured to obtain feature information of the social network of the users, wherein the clustering module is specifically configured to cluster, according to the obtained interest label information and the feature information of the social network of the users, the users having the same category of interest labels to form the cluster.

13. A non-transitory computer readable storage medium having stored therein one or more instructions, which, when executed by a computing device, cause the computing device to:
obtaining, according to user-generated content of a social network, interest label information of users;
clustering, according to the obtained interest label information, users having a same category of interest labels to form a cluster; and
recommending interest labels of the users in the same cluster to each of the users in the cluster, and/or recommending the users in the same cluster to one another as friends with same interests.
